(19) United States
(12) Patent Application Publication
(10) Pub. No.: US 2026/0026514 A1
(43) Pub. Date: Jan. 29, 2026

(54) EDIBLE BAKED PRODUCT THAT DOES NOT INCREASE SERUM INSULIN, RAISE BLOOD GLUCOSE, OR INTERRUPT KETOSIS

(71) Applicants: Marius F. IRIMIES, Blacklick, OH (US); Jason V. SHUGART, Dayton, OH (US); Richard J. ORANGE, Ocean Springs, MS (US)

(72) Inventors: Marius F. IRIMIES, Blacklick, OH (US); Jason V. SHUGART, Dayton, OH (US); Richard J. ORANGE, Ocean Springs, MS (US)

(21) Appl. No.: 19/090,239

(22) Filed: Mar. 25, 2025

Related U.S. Application Data
(60) Provisional application No. 63/569,241, filed on Mar. 25, 2024.

(51) Int. Cl. A21D 13/062; A21D 2/02; A21D 2/16; A21D 2/36; A21D 8/02; A21D 13/04; A21D 13/80; A23L 33/00

(52) U.S. Cl. CPC A21D 13/062; A21D 2/02; A21D 2/165; A21D 2/36; A21D 2/364; A21D 8/02; A21D 13/04; A21D 13/80; A23L 33/30

(57) ABSTRACT

A baked dough food for consumption during fasting, methods of making the same, and methods of fasting that include consumption of the baked dough food are disclosed herein. The baked dough food includes a dry ingredient selected from the group consisting of almond flour, coconut flour, Psyllium husk powder, chia powder, flaxseed powder, and combinations thereof, baking soda, at least one of clarified butter, an oil, cacao butter, almond butter, peanut butter, unsweetened almond milk, or water, a sweetener, and a flavoring agent. The baked dough food does not produce an insulin spike or increased blood glucose level upon consumption.

### RELATED APPLICATIONS

This application claims the benefit of U.S. Provisional Application No. 63/569,241, filed Mar. 25, 2024, the entirety of which is incorporated herein by reference.

### TECHNICAL FIELD

The present invention relates generally to food products, and more particularly to food products for consumption during fasting in the form of a cookie having ingredient, none of which in combination will trigger an insulin spike or increased blood glucose levels upon consumption.

### BACKGROUND

Insulin resistance is the single most significant metabolic issue causing the global rise in obesity. Insulin resistance arises from a reduced sensitivity of cells to insulin, which can lead to a range of metabolic disorders, including type 2 diabetes, cardiovascular disease, non-alcoholic fatty liver disease, Alzheimer's, kidney failure, and autoimmune conditions, among others. Insulin resistance has also been linked to chronic inflammation including many forms of arthritis, oxidative stress, and disturbances in cellular and neural signaling pathways. The condition is thought to be driven by a complex interplay of genetic and environmental factors, including dietary habits, physical inactivity, and other lifestyle factors. As such, understanding the underlying mechanisms that contribute to insulin resistance remains a critical area of research. Developing effective interventions for preventing and treating insulin resistance is crucial for mitigating the adverse health outcomes associated with the condition.

Insulin resistance will develop with frequent nutrient consumption, which leads to prolonged periods of elevated insulin levels. When nutrients are consumed too frequently, cells in the body become less responsive to insulin, further increasing insulin resistance in the cells. This reduced sensitivity can also lead to a state of chronic hyperinsulinemia, where insulin levels remain elevated even during periods of fasting or low nutrient availability. This state can further exacerbate insulin resistance, as cells become desensitized to high insulin levels over time. Consequently, increasing the time periods between nutrient consumption helps to restore normal insulin sensitivity and glucose metabolism, thereby reducing the risk of most metabolic disorders associated with insulin resistance.

Fasting can help return insulin levels to normal by reducing the body's insulin demand. During fasting, the body depletes most of the body's glucose stores, thereby lowering cellular glucose. With no nutrient consumption, there is no stimulation of insulin for extended periods, which allows the cells to reduce insulin resistance levels. Additionally, fasting has been shown to stimulate the production of adiponectin, a hormone that promotes insulin sensitivity and glucose uptake in the body. These effects can help restore insulin sensitivity, leading to improved glucose metabolism and reduced risk for metabolic disorders.

Intermittent fasting (typically less than 24 hour fasting) has been shown to be a solution to reverse insulin resistance, but this process can take many months or years. Plus, the enhanced benefits of chaperone-mediated autophagy are minimal at best when a human fasts for less than 40 hours. Extended fasting with no nutrient consumption is an accelerated solution to reverse insulin resistance with superior and faster results when done correctly. Most people encounter difficulties when trying to fast for more than two days because people are programmed to eat multiple times per day. However, the smallest bite of food can immediately spike insulin, interrupt ketosis, and turn off chaperone-mediated autophagy.

During no-nutrient fasting, cravings develop due to changes in hormonal and neural signaling pathways. As the body's energy stores are depleted during fasting, levels of the hormone ghrelin increase, which stimulates hunger and food-seeking behaviors. Additionally, levels of leptin, a hormone that regulates appetite and energy expenditure, decrease during fasting, further promoting hunger and food cravings. The brain's reward centers may also become activated during fasting, leading to cravings for high-calorie foods. These effects may be particularly pronounced during extended periods of fasting, which can lead to a heightened sense of deprivation and a greater likelihood of overeating once food becomes available.

Ghrelin is a hormone that increases before meals and decreases after eating. Ghrelin induces hunger and is triggered by an empty stomach, functioning independently of insulin and mTOR (mammalian target of rapamycin). When fasting, the stomach releases ghrelin over the first 24 to 30 hours, typically in 4 or 5 cycles. After this period without food, the hypothalamus and pituitary gland stop sending signals to the stomach to produce ghrelin. However, if protein, carbs, or sugars are consumed, or insulin is secreted, then the clock restarts and the hunger pains will return. This makes extended fasting even more difficult (more on extended fasting infra).

Insulin is released by the pancreas in two phases. The first, anticipatory phase occurs when the body expects incoming nutrients. This can be triggered by the taste of sweet (sugar) on the tongue and other sensory inputs signaling that food is about to be consumed. The brain then signals the pancreas to release insulin in preparation for the glucose that will enter the blood. The second phase is the responsive release, which occurs in direct response to increased blood glucose levels after the nutrients are absorbed or if glucose has spiked in the blood.

mTOR is a central regulator of cell growth and metabolism, responding to nutrient availability, growth factors, and cellular energy status. While influenced by insulin under certain conditions, mTOR also responds directly to amino acids and other growth signals.

Thus, a solution is needed to enable longer fasting periods without interrupting the increased metabolic functions of ketosis and autophagy while simultaneously satisfying the hunger cravings. A chewable food item is needed that can satisfy the hunger craving, i.e., that meets the psychological benefit of consuming food, such as chewing, without stimulating insulin or increasing blood glucose levels, which also does not interrupt the metabolic processes of lipolysis or ketosis. A chewable food item, such as a cookie, which has enough flavor to be desirable while meeting the above goals is desired.

### SUMMARY

In all aspects, baked dough food is disclosed that has a dry ingredient having a glycemic index in a range of 0 to 30, baking soda or a leavening agent having a glycemic index in a range of 0 to 30, at least one of clarified butter, an oil, cacao butter, almond butter, peanut butter, unsweetened almond milk, and water, and optionally, a sweetener and/or a flavoring agent. The baked dough does not produce an insulin spike or increased blood glucose level upon consumption. The sweetener is present and is a natural sweetener selected from the group consisting of monk fruit, allulose, stevia, erythritol, xylitol, sorbitol, and combinations thereof. The flavoring agent is present and is selected from the group consisting of cocoa powder or cocoa butter, peanut butter or peanut butter powder, ginger, cinnamon, coffee, matcha, almond butter, and combinations thereof. The baked dough product can include seed, nuts, or butter resulting from nuts, and/or a medium chain triglyceride oil.

In all embodiments, the dry ingredient is selected from the group consisting of almond flour, coconut flour, Psyllium husk powder, chia powder, flaxseed powder, pumpkin seed flour, walnut flour, walnut powder, and combinations thereof. The almond flour can be present and can have 15 g fat and 6 g protein. The coconut flour can be present and can have 1.5 g fat and 2 g protein. The Psyllium flour can be present and can have 0 g fat and 0 g protein.

In one embodiment, the dry ingredient is 32% to 35% wt/wt almond flour and 9% to 10% wt/wt coconut flour, the dough comprises 0.20% to 0.25% wt/wt baking soda, 17% to 31% wt/wt clarified butter, 21% to 22.5% wt/wt sweetener, and 0.2% to 2.5% wt/wt flavoring agent(s). The oil can be selected from the group consisting of olive oil, safflower oil, avocado oil, coconut oil, and combinations thereof.

In another aspect, methods of preparing a baked food product are disclosed that include preparing a dough by mixing the liquid ingredients, then mixing in dry ingredients or mixing the dry ingredients, then adding liquid ingredients, resting the dough for 1 minute to 1440 minutes, forming a cookie shape, and baking the dough. The dry ingredient selected from the group consisting of almond flour, coconut flour, Psyllium husk powder, chia powder, flaxseed powder, pumpkin seed flour, walnut flour, walnut powder, and combinations thereof, and baking soda or a leavening agent with a glycemic index in a range of 0 to 30. The liquid ingredients are selected from the group consisting of clarified butter, a sweetener, an oil, water, unsweetened almond milk, and combinations thereof. The ingredients can also include a flavoring agent. Baking the dough can be at a temperature of 170° C. to 180° C. for 5 to 10 minutes, followed by cooling the baked dough.

In another aspect, methods of fasting are disclosed that include providing a baked dough food as described herein to a user that is fasting for a period of at least 6 hours, consuming, by the user, a pre-selected number of the baked dough food and a glass of water when experiencing ghrelin and waiting 15 to 20 minutes thereafter, and repeating the consuming of baked dough food and water as needed to maintain the fast. The period for the fasting can be less than 24 hours or more than 24 hours. A glass of water is at least 8 fluid ounces. The method can also include instructing the user not to consume the baked dough food during a period of Chaperone-mediated autophagy.

### DETAILED DESCRIPTION

The following description and drawings are illustrative and are not to be construed as limiting. Numerous details are described to provide a thorough understanding of the disclosure. In certain instances, well known or conventional details are not described to avoid obscuring the description. References to one embodiment or an embodiment in the present disclosure can be, but not necessarily, are references to the same embodiment; and, such references mean at least one of the embodiments.

Unless otherwise noted, technical terms are used according to conventional usage. As used herein, the singular forms “a,” “an,” and “the,” refer to both the singular as well as plural, unless the context clearly indicates otherwise. The abbreviation, “e.g.,” is derived from the Latin exempli gratia, which is synonymous with “for example”, and is used herein to indicate a nonlimiting example. As used herein, the term “comprises” means “includes.” All publications, patent applications, patents, and other references mentioned herein are expressly incorporated herein by reference in their entirety.

As used herein, relative terms, such as “substantially,” “generally,” “approximately,” “about,” and the like are used herein to represent an inherent degree of uncertainty that can be attributed to any quantitative comparison, value, measurement, or other representation. These terms are also utilized herein to represent the degree by which a quantitative representation can vary from a stated reference without resulting in a change in the basic function of the subject matter at issue. In certain example embodiments, the term “about” is understood as within a range of normal tolerance in the art for a given measurement, for example, such as within 2 standard deviations of the mean. In certain example embodiments, depending on the measurement “about” can be understood as within 10%, 5%, 1%, 0.5%, 0.1%, 0.05%, or 0.01% of the stated value. Unless otherwise clear from context, all numerical values provided herein can be modified by the term “about.” “Substantially free” as used herein means 1%, 0.5%, 0.1%, 0.05%, or 0.01% or less including zero, and “free” means zero or no measurable, detectable amount.

The present invention is an edible baked food product suitable for consumption and having therapeutic uses. The edible product has a minimal impact on chaperone-mediated autophagy and will not cause insulin blood levels to rise. Disclosed herein is a food in the form of a baked dough, for example a cookie, bar, cake, biscuit, cracker, bread, bun, or the like. The baked dough is made from a dry ingredient or a combination of dry ingredients that each have a low glycemic index. As used herein, a low glycemic index is in a range of 0 to 30. The dry ingredient can be selected from the group consisting of almond flour, coconut flour, Psyllium husk powder, chia powder, flaxseed powder, pumpkin seed flour, walnut powder, walnut flour, and combinations thereof. Other ingredients include baking soda or a leavening agent with a low glycemic index, at least one of clarified butter, olive oil, safflower oil, avocado oil, coconut oil, cacao butter, almond butter, or peanut butter, unsweetened almond milk, water, a sweetener, and a flavoring agent. The baked dough does not produce an insulin spike or increase blood glucose level upon consumption. The baked dough does not trigger hormones or neurotransmitters that interrupt ketosis as demonstrated by a continuous increase in ketones during no-nutrient fasting. Some example leavening agents with a low glycemic index include cream of tartar and yeast.

The sweetener is a natural sweetener selected from the group consisting of monk fruit, stevia, allulose, erythritol, xylitol, sorbitol, and combinations thereof.

In one embodiment, the flavoring agent is selected from the group consisting of cocoa powder or cocoa butter, peanut butter or peanut butter powder, ginger, cinnamon, coffee, matcha, almond butter, and combinations thereof. Other suitable flavorings can include vanilla extract, peanut butter flavoring, hazelnut flavoring, hazelnut powder. These are nonlimiting examples, as other flavorings may be suitable as long as they will not change the resulting product from its essential characteristics.

The baked dough can include seed, nuts, or butter resulting from nuts. The baked dough can also include a medium chain triglyceride oil additionally or as a replacement for the clarified butter.

In one embodiment, the baked dough includes almond flour, coconut flour, baking soda, clarified butter, sweetener, and flavoring agent(s). These ingredient can be present as 32% to 35% wt/wt almond flour; 9% to 10% wt/wt coconut flour; 0.20% to 0.25% wt/wt baking soda; 17% to 31% wt/wt clarified butter (also known as ghee); 21% to 22.5% wt/wt sweetener; and 0.2% to 2.5% wt/wt flavoring agent(s). Other ingredients could include 0% to 25% wt/wt Psyllium husk powder; 0% to 25% wt/wt Chia seed powder; 0% to 25% wt/wt Flaxseed powder.

In one embodiment, the clarified butter is replaced with olive oil. The olive oil can be present in an amount from about 15% to about 30% wt/wt, preferably 25% wt/wt. In another embodiment, the clarified butter is replaced with cacao or cocoa butter. The cacao or cocoa butter can be present in an amount from about 15% to about 35% wt/wt, preferably 29% wt/wt.

In one embodiment, the clarified butter and olive oil is replaced with distilled water. The water can be present in an amount from about 15% to about 30% wt/wt, preferably about 20% wt/wt.

In one embodiment, the clarified butter, olive oil, and distilled water is replaced with unsweetened almond milk. The unsweetened almond milk can be present in an amount from about 15% to about 30% wt/wt, preferably about 20% wt/wt.

In one embodiment, the almond flour has 15 g fat and 6 g protein, the coconut flour has 1.5 g fat and 2 g protein, and the Psyllium flour has 0 g fat and 0 g protein.

In one embodiment, the baked dough includes almond flour, coconut flour, Psyllium husk powder, flaxseed powder or flaxseed flour, Chia seed powder, baking soda, clarified butter, sweetener, and flavoring agent(s). Table 1 below includes ranges for amounts in grams of the various ingredients that can be used in myriad combinations to make the baked dough.

TABLE 1

| Item | Min (grams) | Ideal (grams) | Max (grams) |
|---|---|---|---|
| Almond Flour | 0-150 | 150-175 | 175-200 |
| Coconut Flour | 0-40 | 40-60 | 60-100 |
| Ghee | 40-80 | 80-160 | 160-200 |
| Cocoa powder | 0-25 | 25-40 | 40-80 |
| Peanuts (powdered) | 0-25 | 25-50 | 50-100 |
| Cacao butter | 40-80 | 80-160 | 160-200 |
| Hazelnut (powdered) | 0-25 | 25-50 | 50-100 |

| | Min | Ideal | High |
|---|---|---|---|
| Item | (milliliters) | (milliliters) | (milliliters) |
| Monk fruit sweetener | 0-90 | 90-120 | 120-160 |
| Baking soda or baking powder | 0.5 | 1-2 | 2-4 |
| Salt | 0-1 | 2-3 | 4-6 |
| Psyllium Husk Powder | 0-40 | 40-60 | 60-100 |
| Flaxseed Flour | 0-40 | 40-60 | 60-100 |
| Chia seed Flour | 0-40 | 40-60 | 60-100 |
| Vanilla extract | 0-1 | 1-3 | 3-28 |
| Peanut butter flavor | 0-3 | 3-13 | 13-20 |
| Olive Oil | 40-80 | 80-160 | 160-200 |
| Hazelnut flavor | 0-3 | 3-13 | 13-20 |
| Water | 15-24 | 25-35 | 36-50 |
| Unsweetened Almond Milk | 15-24 | 25-35 | 36-50 |

### EXAMPLES

### Example 1: Chocolate Cookie

Ghee: 100 g
Sweetener: 105 g
Almond flour: 162 g
Coconut flour: 50 g
Cocoa powder: 36 g
Salt: 3 g
Baking soda: 1 g
Vanilla extract: 12 g

The dough was prepared by mixing the ghee, also known as clarified butter, and sweetener for 3 to 5 minutes until the ghee or clarified butter was creamed. Thereafter, the almond flour, coconut flour, baking soda, and flavoring were thoroughly mixed and added to the creamed mixture with mixing until the resulting dough is homogenized. Next, the dough rested for 1 min to 1440 minutes. The resulting dough was then pressed into molds in the shape of a cookie and baked at a temperature in the range of 170° C. to 180° C. for 5 to 10 minutes. The resulting cookies were allowed to cool to 18° C. to 25° C.

Different colorings and flavorings in the appropriate quantities to achieve the desired taste and color can replace the cocoa powder & vanilla extract, as desired to create different variations. Conveniently, powdered colorings and flavorings can be diluted with a small volume of water prior for addition to the mixture, to improve their uniform dispersion therein.

### Example 2: Peanut Butter Cookie

Ghee: 100 g
Sweetener: 105 g
Almond flour: 162 g
Coconut flour: 50 g
Peanut powder: 40 g
Salt: 3 g
Baking soda: 1 g
Peanut butter flavor: 3 g

The dough was prepared by mixing the ghee, also known as clarified butter, and sweetener for 3 to 5 minutes until the ghee or clarified butter was creamed. Thereafter, the almond flour, coconut flour, peanut butter powder, baking soda, and flavoring were thoroughly mixed and added to the creamed mixture with mixing until the resulting dough is homogenized. Next, the dough rested for 1 min to 1440 minutes. The resulting dough was then pressed into molds in the shape of a cookie and baked at a temperature in the range of 170° C. to 180° C. for 5 to 10 minutes. The resulting cookies were allowed to cool to 18° C. to 25° C.

Different colorings and flavorings in the appropriate quantities to achieve the desired taste and color can replace the peanut butter powder and peanut butter flavor to create different variations.

### Example 3: Hazelnut Cookie

Olive oil: 80 g
Sweetener: 110 g
Almond flour: 140 g
Coconut flour: 50 g
Hazelnut powder: 80 g
Salt: 1 g
Baking soda: 1 g
Vanilla extract: 6 g
Hazelnut flavor: 9 g

The dough was prepared by mixing the dry ingredients, sweetener, almond flour, coconut flour, hazelnut powder, baking soda, salt and flavoring. Thereafter, the olive oil was added and mixed until the resulting dough is homogenized. Thereafter, the dough rested for 1 min to 1440 min. Then, the dough was pressed into molds in the shape of a cookie and baked at a temperature in the range of 170° C. to 180° C. for 5 to 10 minutes. The resulting cookies were allowed to cool to 18° C. to 25° C.

Different colorings and flavorings in the appropriate quantities to achieve the desired taste and color can replace the hazelnut powder, vanilla extract, and hazelnut flavor to create different variations. Conveniently, powdered colorings and flavorings can be diluted with a small volume of water prior to addition to the mixture, to improve the uniform dispersion.

While the examples have the cookies made by creaming or mixing the liquid ingredients first, it is also possible to mix all the ingredient simultaneously or to mix the dry ingredients first and add the liquid ingredients to this mixture. In addition to using molds to form the cookie shapes, the cookies may be made by rolling the dough and cutting cookie shapes, by placing dollops of dough onto a baking surface, spreading the dough into pans and cutting bar or cookie shapes after the dough is baked. Additionally, the cookie shapes can be formed using automated commercial machinery that is available today or that is herein after developed.

The baked dough products have numerous advantages: (1) consumption thereof reduces the response of ghrelin which causes the sensation of hunger (e.g., “stomach growling”) without stimulating the release of insulin or mammalian target of rapamycin (mTOR) into the bloodstream, and (2) consumption thereof improves a user's probability of reaching a deep state of chaperone-mediated autophagy (CMA). This is advantageous for (1) intermittent fasters who just want to go longer between meals to reduce insulin resistance and (2) extended fasters (beyond 48 hours) who want to spend considerable time in a deep state of chaperone-mediated autophagy. The user herein can be a human or an animal.

### Implementation During Fasting

For both intermittent fasting and extended fasting, the goal is to avoid the stimulation of insulin and mTOR. Ghrelin stimulation is typically the most challenging time during fasting, which will occur on day 1. Therefore, intermittent fasters who fast for less than 30 hours are always in the state of ghrelin secretion. The baked dough product disclosed herein will help curb hunger without stimulating insulin or mTOR. The only way to improve insulin resistance is to provide longer of periods of time between insulin secretions.

After day 1, the ghrelin will diminish, but the client needs to reach day 3 or later before Chaperone-mediated autophagy and the deep repair system within the body is fully activated. It is critical for clients to be able to go past day 3 in order to reach Chaperone-mediated autophagy. This invention allows those new to fasting to consume the baked dough product without triggering insulin or mTOR and interrupting their progress. One bite of regular bread on day 3 of a fast, will disrupt body's processes and the user who is fasting must start the fasting clock over.

It is important to note that fasting as used herein means “water only” fasting. “Water only” does include coffee and tea with no sugar or sweeteners and no cream or creamers. Both broth is not included nor are any foods that stimulate the release of insulin or mTOR. Bone broth contains amino acids, which will stimulate mTOR and typically insulin as well.

Chaperone-mediated autophagy (CMA) is a selective type of autophagy, a cellular process for degrading and recycling cellular components. In CMA, specific proteins are recognized by a chaperone, usually heat shock cognate 70 (Hsc70), and are then delivered to the lysosome, a cell organelle responsible for degradation. These targeted proteins contain a specific pentapeptide motif, which is recognized by the chaperone. Once at the lysosome, the protein is translocated across the lysosomal membrane and into the lysosome where it is degraded. This process is distinct from other types of autophagy in that it selectively degrades individual proteins rather than entire organelles or large portions of cytoplasm. CMA is important in maintaining cellular homeostasis, especially under stress conditions. A few advantages of CMA include:
a. Mitophagy: CMA contributes to the selective degradation of damaged or dysfunctional mitochondria. While this is more commonly associated with macroautophagy, CMA can target specific mitochondrial proteins for degradation, aiding in mitochondrial quality control and preventing mitochondrial dysfunction.
b. Protein Homeostasis: CMA is crucial in maintaining protein homeostasis by selectively degrading abnormal, misfolded, or damaged proteins. This prevents the accumulation of potentially toxic protein aggregates, which is essential for cell health and function.
c. Clearance of Oxidized Proteins: CMA plays a significant role in removing oxidized proteins, which accumulate under oxidative stress. This helps in protecting cells from oxidative damage and maintaining cellular integrity.
d. Lysosomal Function Maintenance: By degrading specific lysosomal proteins, CMA contributes to the maintenance and function of lysosomes, which are vital for various cellular recycling and repair processes.
e. DNA Damage Response: While CMA is not directly involved in DNA repair, the removal of certain regulatory proteins via CMA can influence the DNA damage response and cell cycle control, indirectly contributing to cellular repair mechanisms.
f. Neuroprotection: In neuronal cells, CMA degrades proteins that, if accumulated, can lead to neurodegenerative diseases. This is a form of cellular repair crucial in maintaining neuronal health and preventing age-related neurodegeneration.
g. Cellular Detoxification: CMA aids in detoxifying the cell by removing proteins that could otherwise form harmful aggregates, contributing to the overall cellular repair and maintenance.
h. Autophagy Regulation: By degrading proteins that regulate autophagy, CMA indirectly influences other autophagic pathways, which are essential for cellular repair and maintenance, especially under stress conditions.
i. Energy Metabolism Regulation: CMA assists in the degradation of enzymes involved in metabolism. This regulation of metabolic processes ensures cellular energy efficiency and contributes to cellular repair and adaptation under varying metabolic states.

For these repair mechanisms to occur, the typical fasting user must avoid any insulin or mTOR activity for 50 to 80 hours, which means water only fasting for that time. Some users that are new to fasting may require over 100 hrs to first reach chaperone-mediated autophagy. Maximum benefits are obtained after reaching this period of optimal repair, so the longer a client can stay in chaperone-mediated autophagy, the more repair will occur. The baked food products disclosed herein do not stimulate the release of insulin or mTOR, so a client can consume these baked dough products without kicking them out of chaperone-mediated autophagy.

### Recommendations for Dosage and Use:

For Intermittent fasting: The baked dough products are intended for use during intermittent fasting when ghrelin is triggered and there is a hungry sensation or a feeling to eat. At such times, it is suggested to consume two cookies and a glass of water, wait for 15 to 20 minutes to determine if hunger has subsided, then repeat the process as long as desired to maintain the body at low insulin levels.

For Extended fasting: If a fasting user has the sensation to eat, they should first try to distract themselves for 5 to 10 minutes to see if the feelings subside. If the fasting user cannot fight the craving or compulsion to eat something, then they consume one or a pre-selected number of baked dough product and a glass of water. Once the baked dough product and glass of water (typically 8 fl. oz.) is consumed, the user should wait 15-20 minutes. This can be repeated as necessary, but the user should strive to avoid consuming the baked dough products while in Chaperone-mediated autophagy. The preselected number of baked dough product can be 1 to 20, with less being more desirable, which of course depends upon the weight per unit for the product. In some embodiments, the baked dough product has a unit weight of 1 g up to 50 grams, but can be within any of the flowing ranges 2 g to 45 g, 3 g to 40 g, 4 g to 35 g, 4 g to 30 g, 4 g to 25 g, 4 g to 20 g, 4 g to 15 g, 4 g to 12 g. Of course, the larger the gram weight per unit, the smaller the preselected number.

It should be noted that the embodiments are not limited in their application or use to the details of construction and arrangement of parts and steps illustrated in the drawings and description. Features of the illustrative embodiments, constructions, and variants may be implemented or incorporated in other embodiments, constructions, variants, and modifications, and may be practiced in various ways. Furthermore, unless otherwise indicated, the terms and expressions employed herein have been chosen for the purpose of describing the illustrative embodiments of the present invention for the convenience of the reader and are not for the purpose of limiting the invention.

Having described the invention in detail and by reference to preferred embodiments thereof, it will be apparent that modifications and variations are possible without departing from the scope of the invention which is defined in the appended claims.

What is claimed is:

1. A baked dough food comprising:
a dry ingredient having a glycemic index in a range of 0 to 30;
baking soda or a leavening agent having a glycemic index in a range of 0 to 30;
at least one of clarified butter, an oil, cacao butter, almond butter, peanut butter, unsweetened almond milk, and water; and
optionally, a sweetener and/or a flavoring agent;
wherein the baked dough does not produce an insulin spike or increased blood glucose level upon consumption.

2. The food of claim 1, wherein the sweetener is present and is a natural sweetener selected from the group consisting of monk fruit, allulose, stevia, erythritol, xylitol, sorbitol, and combinations thereof.

3. The food of claim 1, wherein the flavoring agent is present and is selected from the group consisting of cocoa powder or cocoa butter, peanut butter or peanut butter powder, ginger, cinnamon, coffee, matcha, almond butter, and combinations thereof.

4. The food of claim 1, further comprising seed, nuts, or butter resulting from nuts.

5. The food of claim 1, further comprising a medium chain triglyceride oil.

6. The food of claim 1, selected from the group consisting of almond flour, coconut flour, Psyllium husk powder, chia powder, flaxseed powder, pumpkin seed flour, walnut flour, walnut powder, and combinations thereof.

7. The food of claim 6, wherein almond flour is present and has 15 g fat and 6 g protein.

8. The food of claim 6, wherein coconut flour is present and has 1.5 g fat and 2 g protein.

9. The food of claim 6, wherein Psyllium flour is present and has 0 g fat and 0 g protein.

10. The food of claim 6 wherein the dry ingredient comprises 32% to 35% wt/wt almond flour and 9% to 10% wt/wt coconut flour.

11. The food of claim 10, wherein the baked dough comprises 0.20% to 0.25% wt/wt baking soda; 17% to 31% wt/wt clarified butter; 21% to 22.5% wt/wt sweetener; and 0.2% to 2.5% wt/wt flavoring agent(s).

12. The food of claim 1 wherein the oil is selected from the group consisting of olive oil, safflower oil, avocado oil, coconut oil, and combinations thereof.

13. A method of preparing a baked food product, the method comprising:
preparing a dough by mixing the liquid ingredients, then mixing in dry ingredients or mixing the dry ingredients, then adding liquid ingredients, the dry ingredients comprising:
a dry ingredient selected from the group consisting of almond flour, coconut flour, Psyllium husk powder, chia powder, flaxseed powder, pumpkin seed flour, walnut flour, walnut powder, and combinations thereof, and
baking soda or a leavening agent with a glycemic index in a range of 0 to 30; and
the liquid ingredients being selected from the group consisting of clarified butter, a sweetener, an oil, water, unsweetened almond milk, and combinations thereof,
optionally, a flavoring agent;
resting the dough for 1 minute to 1440 minutes;
forming a cookie shape; and
baking the dough.

14. The method of claim 13, wherein the baking comprises a temperature of 170° C. to 180° C. for 5 to 10 minutes.

15. The method of claim 13, further comprising cooling the baked dough.

16. A method of fasting comprising:
providing a baked dough food according to claim 1 to a user that is fasting for a period of at least 6 hours;
consuming, by the user, a pre-selected number of the baked dough food and a glass of water when experiencing ghrelin and waiting 15 to 20 minutes thereafter;
repeating the consuming of baked dough food and water as needed to maintain the fast.

17. The method of fasting of claim 16, wherein the period of fasting is less than 24 hours.

18. The method of fasting of claim 16, wherein the period of fasting is more than 24 hours.

19. The method of claim 16, wherein a glass of water is at least 8 fluid ounces.

20. The method of claim 19, further comprising instructing the user not to consume the baked dough food during a period of Chaperone-mediated autophagy.
